(19) United States
(12) Patent Application Publication
(10) Pub. No.: US 2012/0298316 A1
(43) Pub. Date: Nov. 29, 2012

(54) VEHICULAR DOOR

(75) Inventor: Hirokazu HIRANO, Tokoname-shi (JP)

(73) Assignee: TOYOTA BOSHOKU KABUSHIKI KAISHA, Aichi-ken (JP)

(21) Appl. No.: 13/467,156

(22) Filed: May 9, 2012

(30) Foreign Application Priority Data
May 23, 2011 (JP) 2011-115023
Mar. 30, 2012 (JP) 2012-081067

(51) Int. Cl. B60J 1/12; B60J 3/02

(52) U.S. Cl. 160/90

(57) ABSTRACT

A vehicular door includes a window including an outer rim, a window frame provided to surround the outer rim of the window, a sunshade, a hook member, and a door trim. The sunshade is provided to a part of the window frame so as to be extended therefrom and housed therein and configured to be extended to block light entering through the window. The hook member is configured to stop an end of the sunshade to keep the sunshade in an extended state. The door trim is provided on a lower side of the window and includes an upper surface portion that is exposed to the window side. The hook member is mounted on the upper surface portion of the door trim.

### CROSS REFERENCE TO RELATED APPLICATION

This application claims priority from Japanese Patent Application Nos. 2011-115023 filed on May 23, 2011 and 2012-81067 filed on Mar. 30, 2012. The entire contents of these priority applications are incorporated herein by reference.

### FIELD OF THE INVENTION

The present disclosure relates to a vehicular door.

### BACKGROUND OF THE INVENTION

A sunshade is provided on a vehicular door that is provided as a side door of a vehicle. The sunshade shields light or sunlight shining through a side window. Such a sunshade is provided to the vehicular door so as to be housed therein and extended therefrom. The sunshade is extended to shield light or sunlight that is shining through the side window. A hook member that keeps the sunshade in an extended state may be provided to the vehicular door and a mounting structure for the mounting such a hook member is disclosed in published patent application JP-A-2002-46469.

The window frame of the vehicular door that surrounds the window may be solid and filled with resin as measures against sympathetic vibration. With such a solid configuration of the window frame, a mounting hole that receives a hook member cannot be formed in the window frame. The Patent Document 1 discloses a mounting structure in which the hook member is previously mounted to a resin frame garnish and the frame garnish is mounted to the window frame. Accordingly, the hook member is fixed to the window frame.

However, in the structure in which the frame garnish having the hook member is mounted to the window frame, the frame garnish is firmly fixed to the window frame. Therefore, if the hook member is necessary to be removed after being mounted to the frame garnish, only the hook member cannot be removed and the entire window frame or the entire vehicular door is required to be replaced with another one. Therefore, if any problems such as a mounting position gap of the hook member occurs after the mounting of the hook member, the hook member cannot be removed easily and the problem cannot be solved promptly.

### SUMMARY OF THE INVENTION

The present invention has been made in view of the aforementioned circumstances. An objective of the present invention is to provide a vehicular door in which a hook member is easily removed after mounting of a hook member that holds a sunshade.

A technology described herein relates to a vehicular door. The vehicular door includes a window including an outer rim, a window frame, a sunshade, a hook member, and a door trim. The window frame is provided to surround the outer rim of the window. The sunshade is provided to a part of the window frame so as to be extended therefrom and housed therein and configured to be extended to block light entering through the window. The hook member is configured to stop an end of the sunshade to keep the sunshade in an extended state. The door trim is provided on a lower side of the window and includes an upper surface portion that is exposed to the window side. The hook member is mounted on the upper surface portion of the door trim.

With the vehicular door, in the manufacturing process, a mounting hole is formed on the upper surface portion of the door trim and the hook member can be mounted to the upper surface portion. Therefore, a mounting member to which the hook member is previously provided is not required to be prepared. Even if any problem occurs after the mounting of the hook member, the hook member can be easily removed and the problem can be solved promptly.

### BRIEF DESCRIPTION OF THE DRAWINGS

FIG. 1 is a front view of a vehicle door of an embodiment;

FIG. 2 is an enlarged perspective view of a part of the vehicle door in adjacent to a hook member;

FIG. 3 is a cross-sectional view of the part of the vehicle door in FIG. 2 taken along a line and seen from above in FIG. 2;

FIG. 4 is a perspective view of a part of an upper surface portion of a door trim and the hook member provided on the part of the upper surface portion seen from a front side;

FIG. 5 is a perspective view of a part of the upper surface portion of the door trim and the hook member provided on the part of the upper surface portion seen from a rear side;

FIG. 6 is an exploded perspective view of a part of the upper surface portion of the door trim and a main body of the hook member and a clip portion;

FIG. 7 is a rear view of the main body of the hook member;

FIG. 8 is a plan view of a clip portion of the hook member;

FIG. 9 is a perspective view of the hook member and the upper surface portion of the door trim in a process (1) in which the hook member is mounted to a part of the upper surface portion;

FIG. 10 is a perspective view of the hook member and the upper surface of the door trim in a process (2) in which the hook member is mounted to a part of the upper surface portion;

FIG. 11 is a perspective view of the hook member and the upper surface portion of the door trim in a process (3) in which the hook member is mounted to a part of the upper surface portion;

FIG. 12 is a cross-sectional view of the upper surface portion of the door trim and the hook member that is mounted to the upper surface portion taken along a height direction of the hook member;

FIG. 13 is a perspective view of a hook member according to a second embodiment;

FIG. 14 is a cross-sectional view of the hook member according to the second embodiment;

FIG. 15 is a cross-sectional view of the hook member taken along an A-A line in FIG. 14;

FIG. 16 is a cross-sectional view of the hook member taken along a B-B line in FIG. 14;

FIG. 17 is a plan view of a clip portion and the upper surface portion of the door trim in a process in which the clip portion is mounted to the upper surface portion; and

FIG. 18 is a plan view of the clip portion that is mounted to the upper surface portion of the door trim.

### DETAILED DESCRIPTION OF THE PREFERRED EMBODIMENTS

### First Embodiment

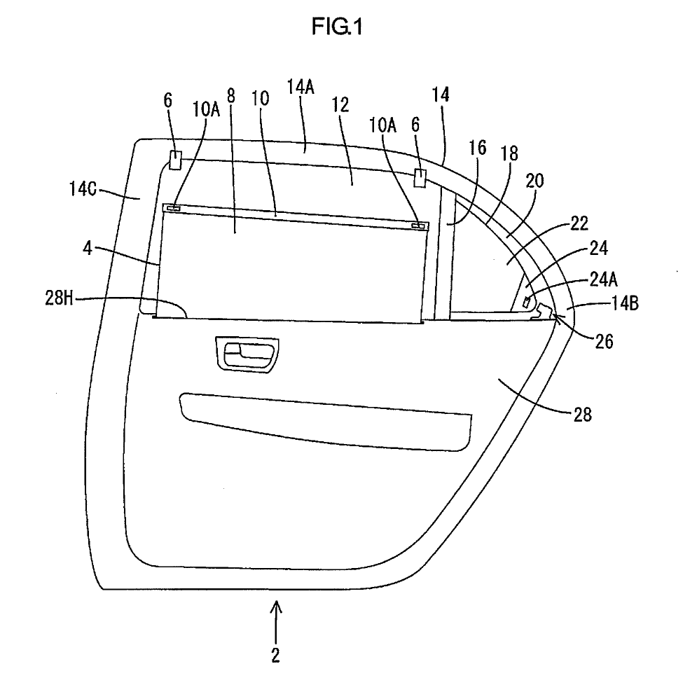

The first embodiment will be explained with reference to the drawings. A vehicle door 2 of the first embodiment will be explained with reference to FIG. 1. As illustrated in FIG. 1, the vehicle door 2 includes side windows (an example of a window) 12, 20. Each of the side windows 12, 20 is defined by a division frame that is a part of a window frame 14. The side window 12 is provided on a vehicle front side and the side window 20 is provided on a vehicle rear side. An outer rim of each side window 12, 20 is surrounded by the window frame 14. A door trim 28 is provided on a lower side of each side window 12, 20. The vehicle front side corresponds to a left side in FIG. 1 and the vehicle rear side corresponds to a right side in FIG. 1.

The window frame 14 is formed of a metal material and includes a straight portion 14A, a curved portion 14B and a front rim portion 14C. The straight portion 14A surrounds an upper outer rim of the side windows 12, 20. The curved portion 14B is formed to be bent from the straight portion 14A and surrounds a vehicle rear side outer rim. The front rim portion 14C surrounds a front outer rim of the side window 12. Each of the straight portion 14A, the curved portion 14B and the front rim portion 14C is formed in a hollow shape. Especially in the present embodiment, no garnish is provided to the window frame 14 and the window frame 14 (the straight portion 14A, the curved portion 14B and the front rim portion 14C) is exposed to an inner space of a vehicular compartment. The window frame 14 (the straight portion 14A, the curved portion 14B and the front rim portion 14C) is not configured by connecting two hollow members but configured by one component. For example, the window frame 14 is configured by a metal plate with sheet metal processing so as to connect a peripheral surface of a hollow structure.

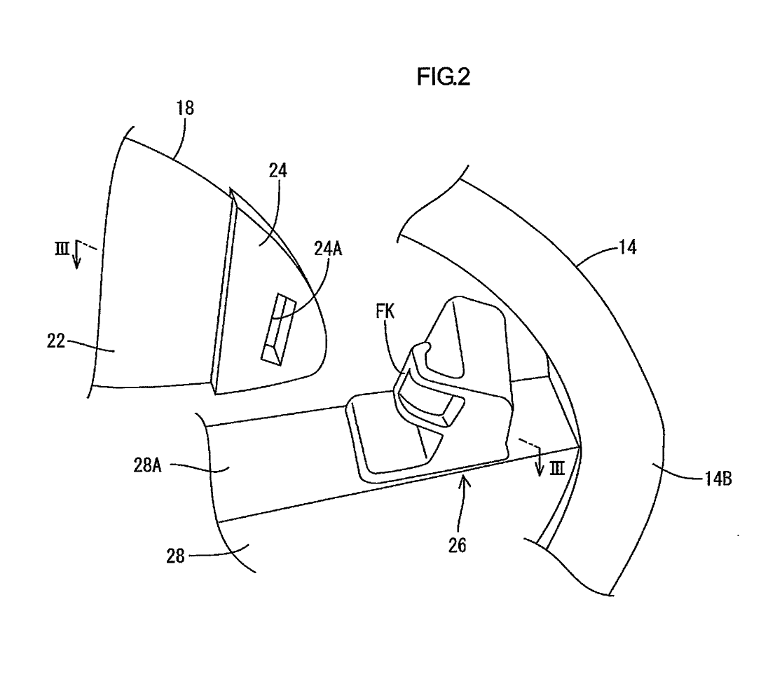

A first sunshade 4 is provided at a lower portion of the side window 12 that is provided on the vehicle front side. The first sunshade 4 includes a first blind sheet 8 and a first frame 10. The first blind sheet 8 is extended to shield light shining through the side window 12. The first frame 10 is attached to a distal end portion of the first blind sheet 8. A housing opening 28H is formed in a part of an upper surface portion 28A of the door trim 28 (see FIG. 2) that is located on a lower side of the side widow 12. The first blind sheet 8 is housed in the housing opening 28H and extended from the housing opening 28H by a rewinding mechanism (not illustrated). Therefore, the first blind sheet 8 is expanded and rewound in an up-and-down direction of a vehicle (in an up-and-down direction in FIG. 1).

As illustrated in FIG. 1, the first frame 10 is attached to a distal end portion of the first blind sheet 8 along its end side. A first stopper hole 10A is formed on either ends of the first frame 10. Hooks 6 are provided on the straight portion 14A of the window frame 14 such that each of the hooks 6 corresponds to each of the first stopper holes 10A when the first sunshade 4 is extended. Mounting holes (not illustrated) are formed in the straight portion 14A of the window frame 14 and the hooks 6 are mounted to the mounting holes to be fixed to the straight portion 14A of the window frame 14 with screws. A distal end of the hook 6 is formed in a hooked shape and the hook 6 is engaged with the first stopper hole 10A provided in the first sunshade 4. The engagement of the hooks 6 and the first stopper holes 10A keeps the first sunshade 4 in a state in that the first blind sheet 8 is extended.

A second sunshade (an example of a sunshade) 18 is provided to the division frame 16. The second sunshade 18 includes a second blind sheet 22 and a second frame 24. The second blind sheet 22 is extended to shield light shining through the side window 20 that is provided on the vehicle rear side. The second frame 24 is provided on a distal end portion of the second blind sheet 22. A housing opening (not illustrated) is provided in the division frame 16. The second blind sheet 22 is housed in the housing opening and extended from the housing opening by a rewinding mechanism (not illustrated). Therefore, the second blind sheet 22 moves along the upper surface portion 28A of the door trim 28 that is along a front-and-rear direction of the vehicle (a left-and-right direction in FIG. 1) to be housed in and expanded from the housing opening.

As illustrated in FIG. 1, the second frame 24 is provided at a distal end corner of the second blind sheet 22 and formed in substantially a triangle so as to follow a shape of the distal end corner. A second stopper hole 24A is formed at a distal end of the second frame 24. A hook member 26 is provided on a vehicle rear side part of the upper surface portion 28A of the door trim 28. The hook member 26 is provided directly to the upper surface portion 28A of the door trim 28.

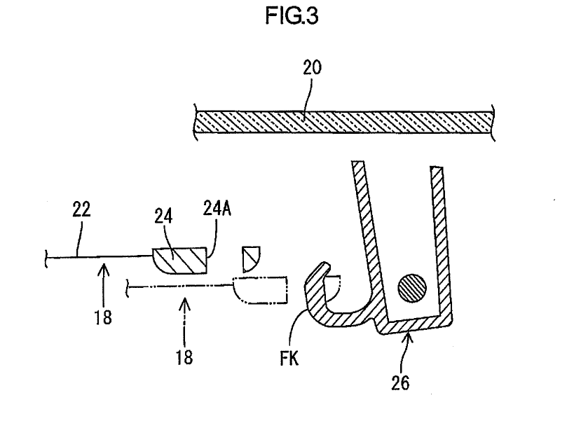

A configuration of the hook member 26 will be explained with reference to FIGS. 2 to 5. As illustrated in FIGS. 2 and 3, the hook member 26 includes a stopper hook FK such that the second stopper hole 24A corresponds to the stopper hook FK when the second sunshade 18 is extended in the front-and-rear direction (the left-and-right direction in FIG. 1). The stopper hook FK is formed in a hooked shape so as to be coupled to the second stopper hole 24A formed in the second frame 24 of the second sunshade 18. The stopper hook FK is coupled to the second stopper hole 24A and the coupling keeps the second sunshade 18 such that the second blind sheet 22 is extended (see a two-dot chain line in FIG. 3).

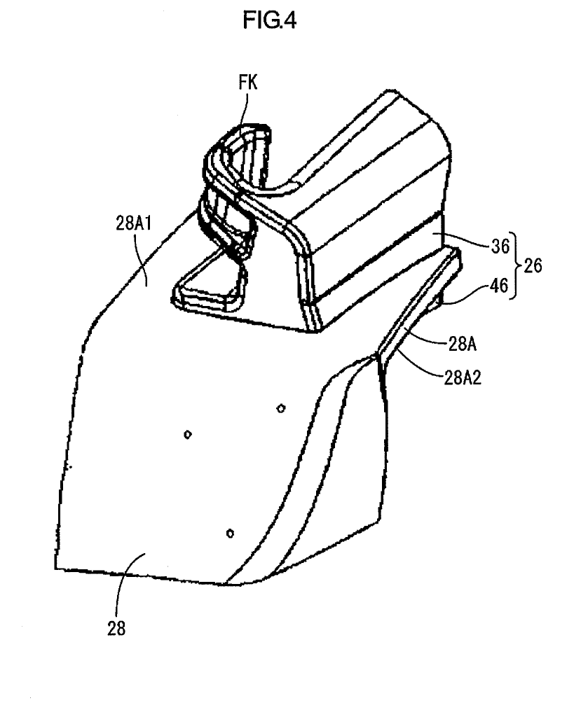

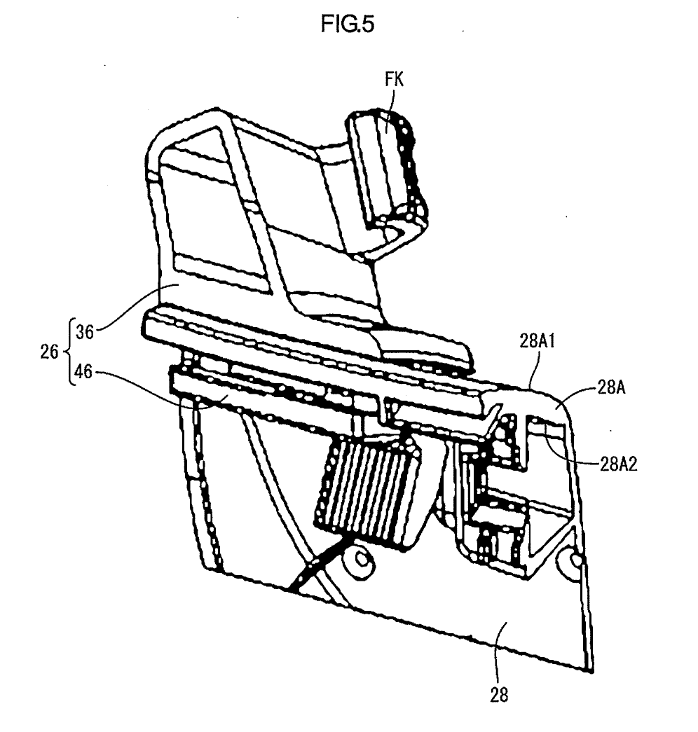

As illustrated in FIGS. 4 and 5, the hook member 26 includes a main body 36 and a clip portion 46. The main body 36 is provided on a front surface 28A1 of the upper surface portion 28A of the door trim 28. The clip portion 46 is provided on a rear surface 28A2 of the upper surface portion 28A of the door trim 28. The main body 36 and the clip portion 46 are fitted to each other and coupled to each other to form the hook member 26. The main body 36 and the clip portion 46 sandwich the upper surface portion 28A of the door trim 28 from the front and rear sides. Accordingly, the hook member 26 is provided on the upper surface portion 28A of the door trim 28.

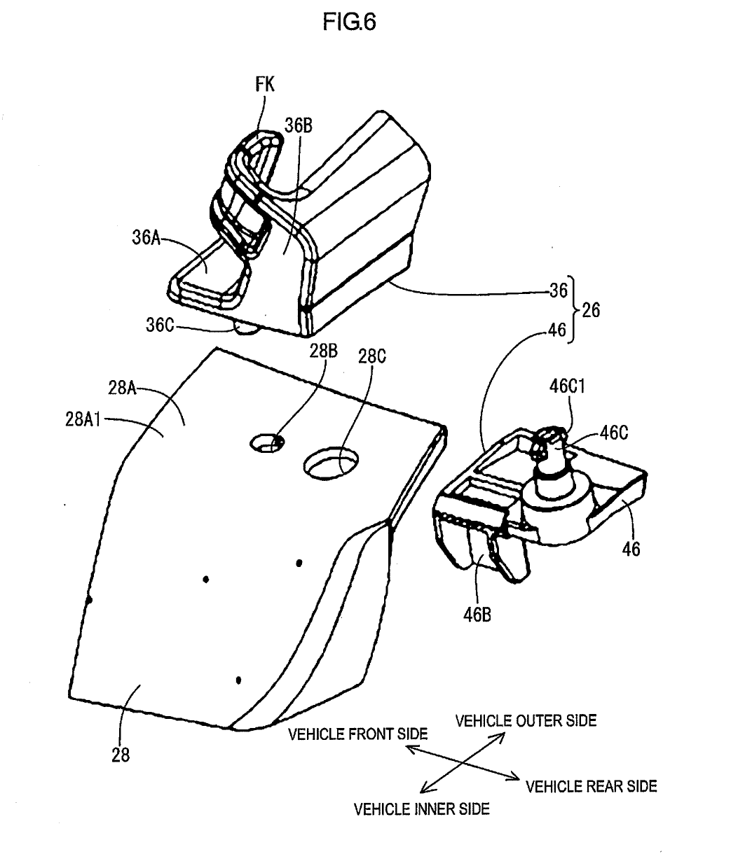

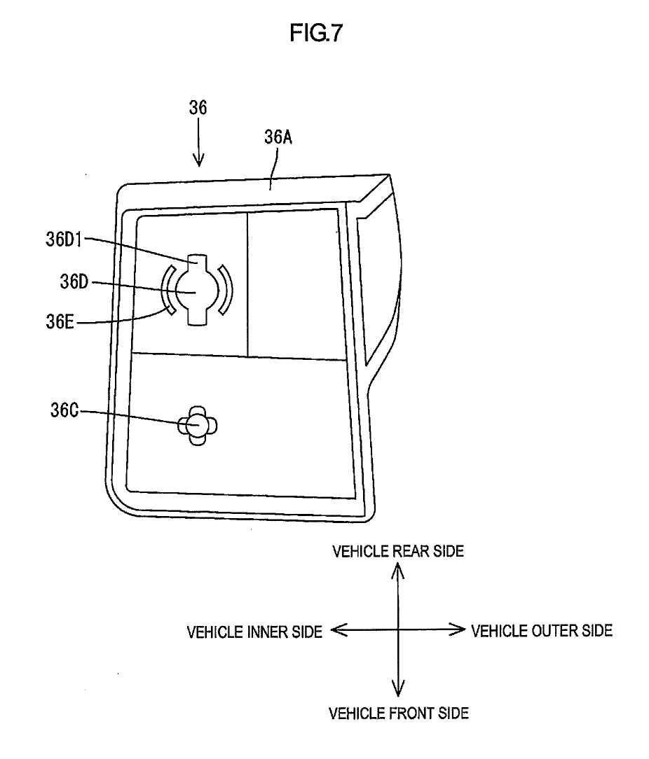

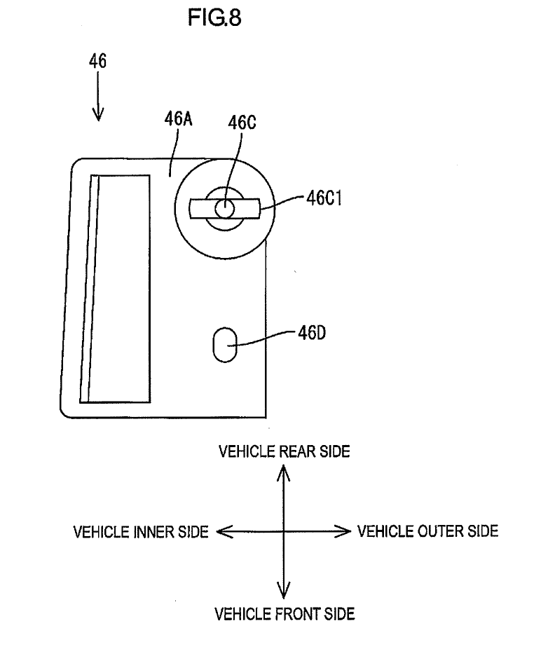

Next, mounting of the hook member 26 to the upper surface portion 28A of the door trim 28 will be explained in detail with reference to FIGS. 6 to 8. The arrangement direction of the main body 36 and the clip portion 46 in FIG. 6 corresponds to the arrangement direction of the main body 36 and the clip portion 46 in a state that the hook member 26 is mounted on the upper surface portion 28A of the door trim 28. Rear surfaces of the main body 36 and the clip portion 46 in the state of FIG. 6 are illustrated in FIGS. 7 and 8. The directions described in each of FIGS. 6 to 8 correspond to each other. In the following, the front and rear sides of the vehicle in the state of FIG. 6 corresponds to the front and rear sides of the main body 36 (the clip portion 46), respectively, and the inner and outer sides of a vehicle compartment in the state of FIG. 6 corresponds to the inner and outer sides of the main body 36 (the clip portion 46), respectively, and the upper and lower sides of the vehicle in the state of FIG. 6 corresponds to the upper and lower sides of the main body 36 (the clip portion 46), respectively.

The main body 36 of the hook member 26 will be explained. As illustrated in FIG. 6, the main body 36 includes a contact portion 36A and a lifted portion 36B. The contact portion 36A is formed in a flat plate and comes in contact with the front surface 28A1 of the upper surface portion 28A of the door trim 28. The lifted portion 36B is lifted up from a part of the contact portion 36A. The stopper hook FK is formed on an upper end portion of the lifted portion 36B that faces the second sunshade 18. The stopper hook FK extends obliquely upward from the upper end portion of the lifted portion 36B. As illustrated in FIG. 7, a first coupling pin 36C, a first coupling hole 36D and a guide 36E are formed on the rear surface of the main body 36 (on the rear surface of the contact portion 36A). The first coupling pin 36C is formed to axially project from the contact portion 36A downwardly (refer to FIG. 6). The first coupling hole 36D is formed in a key hole and is configured by a circular opening and side openings 36D1 each of which extends from the circular opening toward the front side and the rear side of the main body 36. Two guides 36E are provided to surround either sides of the first coupling hole 36D. Each of the guides 36E is formed in an arched shape and projects downwardly.

Next, the clip portion 46 of the hook member 26 will be explained. As illustrated in FIG. 6, the clip portion 46 includes a contact portion 46B and a lifted portion 46B. The contact portion 46A is formed in a flat plate that comes in contact with the rear surface of the upper surface portion 28A of the door trim 28. The lifted portion 46B is lifted up from a part of the contact portion 46A. As illustrated in FIG. 8, a second coupling pin 46C and a second coupling hole 46D are provided on a rear surface of the clip portion 46 (on a rear surface of the contact portion 46A). The second coupling pin 46C is formed to axially project from the contact portion 46A upwardly. Projections 46C1 are provided on a distal end of the second coupling pin 46C. Ends of the projections 4601 extend and project from the second coupling pin 46C in opposite directions. The second coupling hole 46D is formed to have an ellipsoidal opening.

Next, a part of the upper surface portion 28A of the door trim 28 to which the hook member 26 is mounted will be explained. As illustrated in FIG. 6, a first mounting hole 28B and a second mounting hole 28C are formed on a portion of the upper surface portion 28A of the door trim 28 to which the hook member 26 is mounted. The first mounting hole 28B and the second mounting hole 28C are formed through the upper surface portion 28A. The first mounting hole 28B is formed such that the first coupling pin 36C of the main body 36 is inserted therethrough. The second mounting hole 28C is formed such that the second coupling pin 46C of the clip portion 46 and the guides 36E are inserted therethrough. The second mounting hole 28C is formed such that an opening rim of the second mounting hole 28C substantially comes in contact with outer surfaces of the guides 36E when the guides 36E are inserted through the second mounting hole 28C. The distal end of the first coupling pin 36C of the main body 36 slightly projects downwardly from the rear surface 28A2 of the upper surface portion 28A when the first coupling pin 36C is inserted through the second mounting hole 28C of the upper surface portion 28A.

The first coupling hole 36D of the main body 36 is formed to receive the second coupling pin 46C after being positioned such that the projection 4601 of the second coupling pin 46C corresponds to the side opening 36D1 of the first coupling hole 36D. The second coupling hole 46D of the clip portion 46 is formed to receive the first coupling pin 36C. The main body 36 is moved closer to the front surface 28A1 of the upper surface portion 28A of the door trim 28 and the clip portion 46 is moved closer to the rear surface 28A2 of the upper surface portion 28A such that the main body 36 and the clip portion 46 get closer to each other. Accordingly, the first coupling pin 36C is inserted through the first mounting hole 28B on the upper surface portion 28A and inserted in the second coupling hole 46D. Also, the second coupling pin 46C is inserted through the second mounting hole 28C on the upper surface portion 28A and inserted through the first coupling hole 36D.

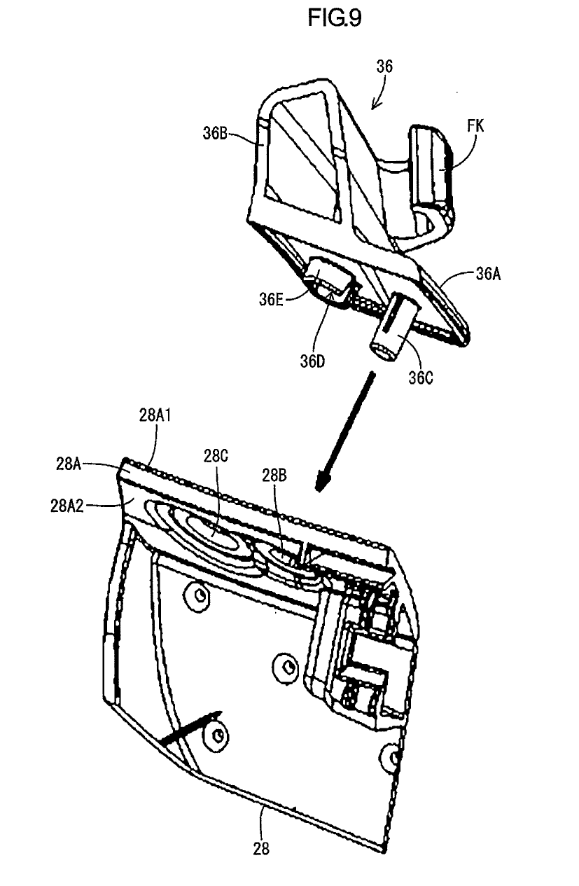

A mounting method of mounting the main body 36 and the clip portion 46 of the hook member 26 to the upper surface portion 28A of the door trim 28 will be explained with reference to FIGS. 9 to 12.

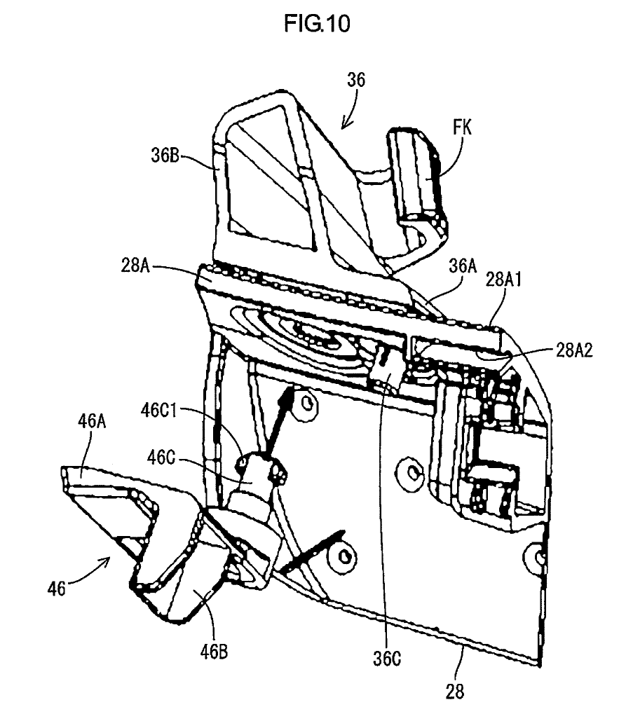

In mounting the hook member 26 to the upper surface portion 28A of the door trim 28, the contact portion 36A of the main body 36 of the hook member 26 is provided on the front surface 28A1 of the upper surface portion 28A. As illustrated in FIG. 9, the main body 36 is positioned such that the first coupling pin 36 corresponds to the first mounting hole 28B and the first coupling hole 36D corresponds to the second mounting hole 28C. Then, the first coupling pin 36C is inserted through the first mounting hole 28B and the guide portions 36E provided on either sides of the first coupling hole 36D are inserted through the second mounting hole 28C (see FIG. 9). Accordingly, the contact portion 36A comes in contact with the front surface of the upper surface portion 28A of the door trim 28 and the main body 36 is maintained to be fixed horizontally (in the front-and-rear direction of the vehicle, in the inner-and-outer direction of the compartment) with respect to the upper surface portion 28A by the first coupling pin 36C and the guide portions 36E, as illustrated in FIG. 10.

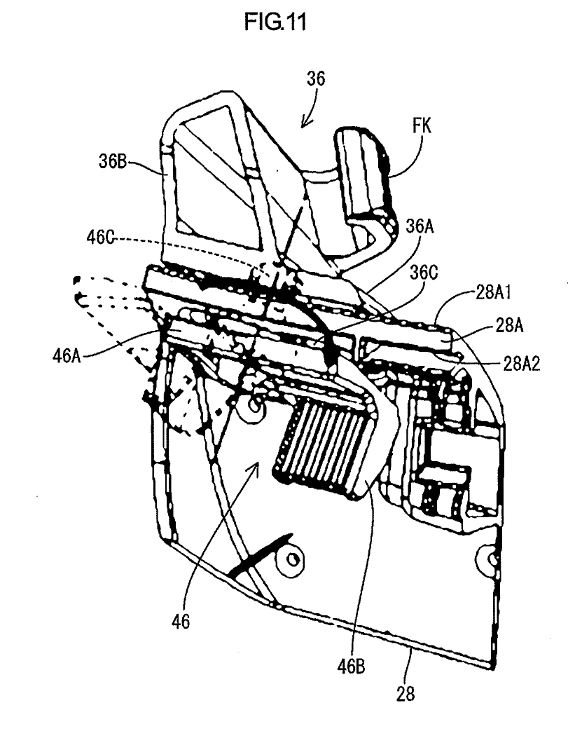

Next, the contact portion 46A of the clip portion 46 of the hook member 26 is provided on the rear surface 28A2 of the upper surface portion 28A. As illustrated in FIG. 10, the clip portion 46 is positioned such that the second coupling pin 46C corresponds to the second mounting hole 28C. In the state of the clip portion 46 illustrated in FIG. 6, a shape of the projection 46C1 of the second coupling pin 46C does not fit to a shape of the side openings 36D1 of the first coupling hole 36D. The clip portion 46 is required to be rotated by approximately 90 degrees such that the projection 46C1 fits to the side openings 36D1. Specifically, each of the side openings 36D1 of the first coupling hole 36D is formed to extend from the middle portion of the first coupling hole 36D to the front side and the rear side of the main body, respectively. The clip portion 46 is positioned such that the second coupling pin 46C corresponds to the second coupling hole 28C and the clip portion 46 is rotated in a clockwise direction around an axis of the second coupling pin 46C by 90 degrees from the state illustrated in FIG. 6. The rotated state of the clip portion 46 is illustrated in FIG. 10. Accordingly, the shape of the projection 46C1 of the second coupling pin 46C fits to the side openings 36D1 of the first coupling hole 36D. Then, the clip portion 46 is moved closer to the rear surface 28A2 of the upper surface portion 28A (refer to an arrow in FIG. 10). Accordingly, the second coupling pin 46C is inserted through the second mounting hole 28C and subsequently inserted through the first coupling hole 36D (illustrated by dashed lines in FIG. 11).

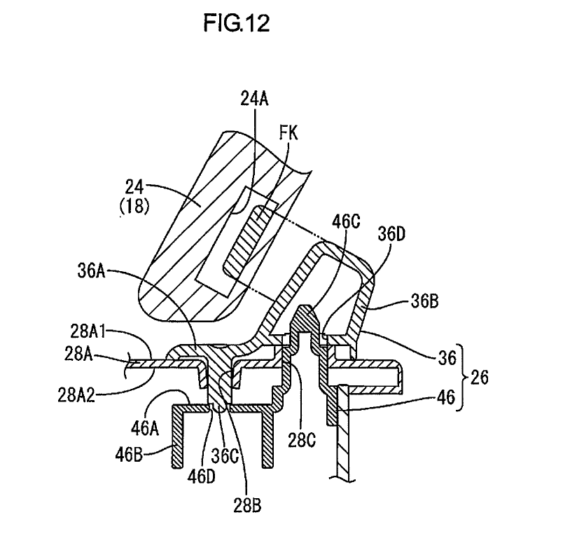

Next, in the state of the second coupling pin 46C being inserted through the first coupling hole 36D, the clip portion 46 is rotated in a counterclockwise direction around the axis of the second coupling pin 46C by 90 degrees (in a direction illustrated by an arrow in FIG. 11) as illustrated in FIG. 11. Accordingly, the side openings 36D1 of the first coupling hole 36D do not overlap the projection 46C1 of the second coupling pin 46C and this fixes the second coupling pin 46C to the first coupling hole 36D. The distal end of the first coupling pin 36C projects slightly from the rear surface 28A2. If the clip portion 46 is rotated, the second coupling hole 46D of the contact portion 46A is moved away from the rear surface 28A2 of the upper surface portion 28A. After the rotation of the clip portion 46 is completed, the contact portion 46A comes in contact with the rear surface 28A2 of the upper surface portion 28. Thus, the distal end of the first coupling pin 36C that is projected from the rear surface 28A2 of the upper surface portion 28A is inserted in the second coupling hole. Accordingly, the clip portion 46 is arranged on the rear surface 28A2 of the upper surface portion 28A, and the main body 36 and the clip portion 46 are fitted to each other with sandwiching the upper surface portion 28A therebetween. According to the above steps, the hook member 26 (the main body 36 and the clip portion 46) is mounted to the upper surface portion 28A of the door trim 28. In the state that the main body 36 and the clip portion 46 are fitted to each other with sandwiching the upper surface portion 28A therebetween, the main body 36 and the clip portion 46 are fixed to each other with sandwiching the upper surface portion 28A therebetween, as illustrated in FIG. 12.

When the hook member 26 is removed from the upper surface portion 28A, the hook member 26 is removed therefrom by executing the reverse procedure to mounting the hook member 26 to the upper surface portion 28A. Specifically, the second coupling hole 46D of the contact portion 46A is separated slightly from the rear surface 28A2 of the upper surface portion 28A and the clip portion 46 is rotated in a counterclockwise direction around the axis of the second coupling pin 46C by 90 degrees. Accordingly, the second coupling pin 46C is removed from the first coupling hole 36D and the clip portion 46 is removed from the upper surface portion 28A. Afterwards, the main body 36 is removed from the upper surface portion 28A. Thus, the hook member 26 of the present embodiment is easily mounted to the upper surface portion 28A of the door trim 28 and easily removed from the upper surface portion 28A of the door trim 28. Further, the hook member 26 is mounted to the upper surface portion 28A of the door trim 28, and this fixes the hook member 26 to the upper surface portion 28A. Therefore, the hook member 26 mounted to the upper surface portion 28A of the door trim 28 is preferably used as a member that keeps the second blind sheet 22 of the second sunshade 18 to be extended.

In the vehicular door 2 of the present embodiment, the hook member 26 is not provided on the bent portion 14B of the window frame 14 but on the upper surface portion 28A of the door trim 28. Therefore, in the manufacturing process, the first mounting hole 28B and the second mounting hole 28C are formed in the upper surface portion 28A of the door trim 28 and accordingly the hook member 26 is mounted to the upper surface portion 28A. Therefore, a mounting member to which the hook member 26 is previously mounted is not necessary to be required. Further, the mounted hook member 26 can be easily removed from the upper surface portion 28A. Therefore, even if any problem occurs after the hook member 26 is mounted to the door trim, the hook member 26 can be removed from the door trim promptly and the problem is solved promptly. A mounting hole to which the hook member 26 is mounted (the first mounting hole 28B and the second mounting hole 28C of the present embodiment) can be easily provided on the upper surface portion 28A of the door trim 28. Therefore, the hook member 26 can be easily mounted to the vehicular door 2.

In the vehicular door 2 of the present embodiment, the second sunshade 18 is extended and contracted along the upper surface portion of the door trim 28 or along a front-and-rear direction of the vehicle. Accordingly, the second sunshade 18 is extended and contracted along the upper surface portion 28A of the door trim 28 and also the second sunshade 28 is kept in an extended state and the hook member 26 that can be easily removed is mounted.

In the vehicular door 2 of the present embodiment, the window frame 14 includes the bent portion 14B on the vehicle rear side. The bent portion 14B is bent compared to other portions of the window frame 14. The hook member 26 is provided on a portion of the upper surface portion 28A of the door trim 28 that is close to the bent portion 14B. It is difficult to mount the hook member 26 on the bent portion 14B of the window frame 14 due to its bent structure. According to the vehicular door of the present embodiment, the hook member 26 is mounted to a portion of the upper surface portion 28A that is close to the bent portion 14B, and this achieves a configuration that the hook member 26 that is easily removable is mounted to a portion of the upper surface portion 28A close to the bent portion 14B.

In the vehicular door 2 of the present embodiment, the lifted portion 36B is provided on the main body 36 of the hook member 26. Accordingly, when the main body 36 is provided on the front surface 28A1 of the upper surface portion 28A, the lifted portion 36B is held by an operator and the main body 36 can be moved close to the front surface 28A1 of the upper surface portion 28A. This makes easy to provide the main body 36 on the front surface 28A1 of the upper surface portion 28A.

In the vehicular door 2 according to the present embodiment, the lifted portion 46B is provided on the clip portion 46 of the hook member 26. Accordingly, when the clip portion 46 is rotated around the axis of the second coupling pin 46C with the second clip pin 46C being inserted through the first coupling hole 36D, the lifted portion 46B is held and the clip portion 46 can be rotated. This makes the clip portion 46 to be rotated easily.

In the vehicular door 2 of the present embodiment, if the clip portion 46 is rotated around an axis of the second coupling pin by 90 degrees with the second coupling pin 46C of the clip portion 46 of the hook member 26 being inserted in the first coupling hole 36D, the main body 36 and the clip portion 46 of the hook member 26 can be fixed to the upper surface portion 28A of the door trim 28. Thus, the hook member 26 is easily fixed to the upper surface portion 28A of the door trim 28.

### Second Embodiment

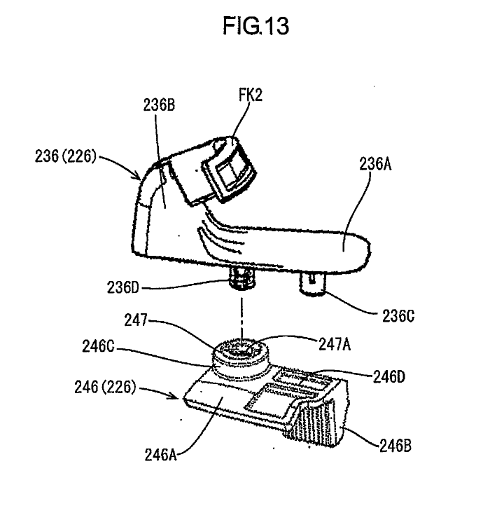

A second embodiment will be explained with reference to FIGS. 13 to 18. In the second embodiment, same symbols and numbers are applied to parts same as those in the above embodiment and explanation thereof is omitted. In the second embodiment, a structure of a hook member is different from that in the above embodiment.

In the above embodiment, the main body of the hook member includes the first coupling hole and the clip member of the hook member includes the second coupling pin. In a hook member 226 of the second embodiment, a main body 236 includes a second coupling pin 236D and a clip portion 246 includes a first coupling hole 247A.

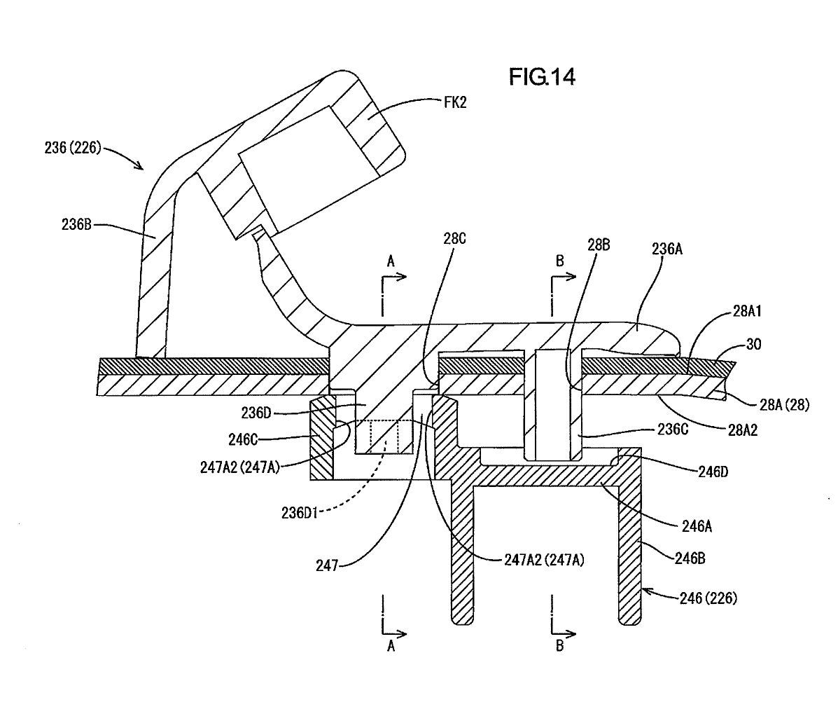

A configuration of the main body 236 will be explained. As illustrated in FIGS. 13 and 14, the main body 236 comes in contact with the upper surface 28A1 of the upper surface portion 28A of the door trim 28. The main body 236 includes an elongated contact portion 236A and a lifted portion 236B that is lifted upwardly from one end portion of the contact portion 236A in its elongated direction.

A stopper hook FK2 (a stopper portion) is formed on an upper end portion of the lifted portion 236B and the stopper hook FK2 extends obliquely upward from the upper end portion of the lifted portion 236B. The stopper hook FK2 is formed in a hooked shape and engaged with the second frame 24 (refer to FIG. 1) of the second sunshade 18. In FIGS. 13 and 14, the right side corresponds to the vehicle front side (closer to the second sunshade 18) and the left side corresponds to vehicle rear side.

A first coupling pin 236C and a second coupling pin 236D are provided on a rear surface of the main body 236 (on a rear side of the contact portion 236A). Each of the first coupling pin 236C and the second coupling pin 236D is formed to axially project toward the upper surface portion 28A of the door trim 28 (eventually toward the clip portion 246).

As illustrated in FIG. 14, the first coupling pin 236C is inserted through the first mounting hole 28B formed through the upper surface portion 28A of the door trim 28. The first coupling pin 236C has a length so as to project downwardly (toward the clip portion 246) from the rear surface 28A2 of the upper surface portion 28A when being inserted through the first mounting hole 28B.

The second coupling pin 236D is inserted through the second mounting hole 28C that is formed through the upper surface portion 28A of the door trim 28. Specifically, as illustrated in FIG. 14, the second coupling pin 236D is formed in substantially a columnar shape having a diameter smaller at its distal end portion than its basal end portion and the basal end portion is fitted to the second mounting hole 28C.

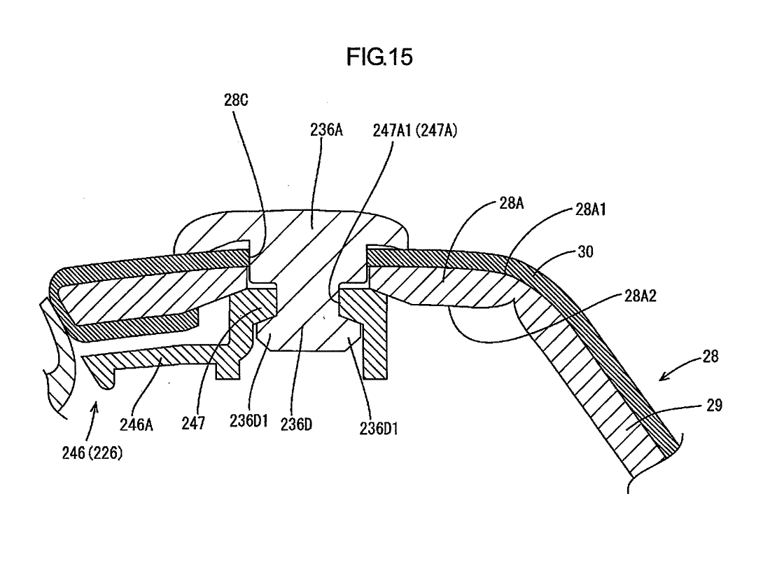

The second coupling pin 236D has a length such that its distal end portion projects downwardly (toward the clip portion 246) from the rear surface 28A2 of the upper surface portion 28A when being inserted through the second mounting hole 28C. As illustrated in FIG. 15, two projected portions 236D1 are formed on an outer peripheral surface of the distal end portion of the second coupling pin 236D. Each of the projected portions 236D1 projects outwardly in opposite directions.

Next, a configuration of the clip portion 246 will be explained. As illustrated in FIGS. 13 and 14, the clip portion 246 includes a clip board portion 246A and a lifted portion 246B. The clip board portion 246A is formed in a flat plate and the lifted portion 2468 is lifted from a part of the clip base board portion 246A.

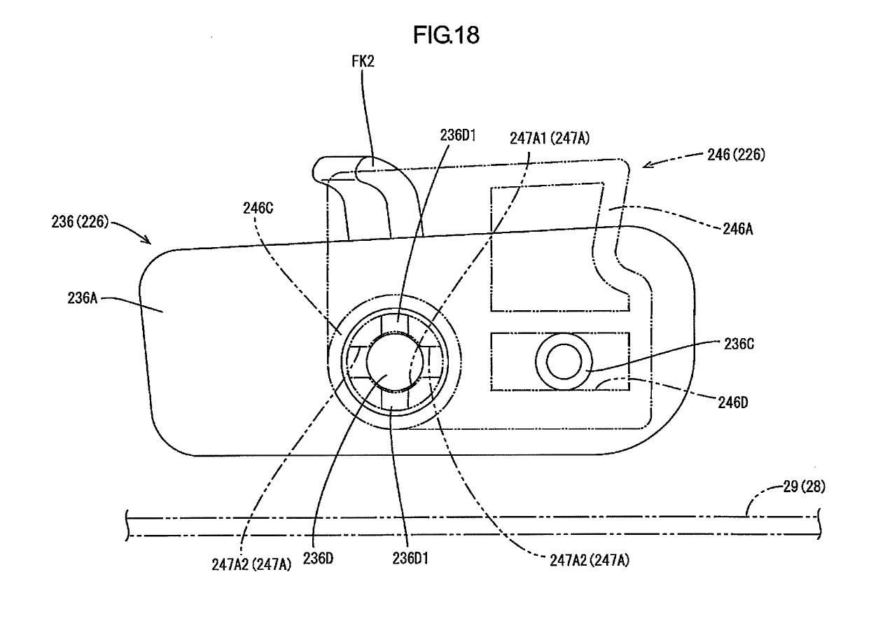

As illustrated in FIG. 13, a cylindrical portion 246C formed in a cylindrical shape is formed on a portion of the clip base board portion 246A that overlaps the second coupling pin 236D. As illustrated in FIGS. 13 and 18, a engagement groove 246D is formed on a portion of the clip base board portion 246A that overlaps the first coupling pin 236C.

As illustrated in FIG. 14, the cylindrical portion 246C has an upper wall portion 247 that face the upper surface portion 28A of the door trim 28. A first coupling hole 247A is formed in the upper wall portion 247 corresponding to the second coupling pin 236D.

As illustrated in FIGS. 13 and 18, the first coupling hole 247A is formed a key hole. Specifically, the first coupling hole 247A is configured by a circular main opening 247A1 (refer to FIG. 15) and a pair of side openings 247A2 (refer to FIG. 18). The distal end portion of the second coupling pin 236D is inserted through the main opening 247A1. The side openings 247A2 are communicated with the main opening 247A1 and each of the side openings 247A2 extends in the vehicle front side and the vehicle rear side. Each of the side openings 247A2 extends in opposite directions from the main opening 247A1.

The coupling groove 246D is formed in a rectangular shape with a plan view and formed in a groove having a depth along a thickness direction of the clip base board portion 246A.

The first coupling hole 247A is formed so as to receive the second coupling pin 236D therethrough with the projected portions 236D1 of the second coupling pin 236D overlapping the side openings 247A2 of the first coupling hole 247A.

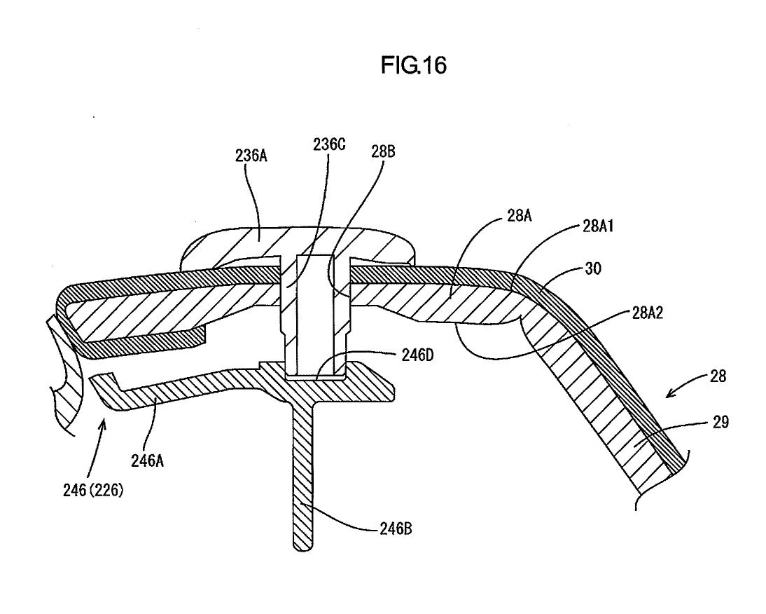

The coupling groove 246D is formed so as to receive the first coupling pin 236C. As illustrated in FIG. 16, a width of the coupling groove 246D is substantially equal to a diameter of the distal end portion of the first coupling pin 236C.

The main body 236 and the clip portion 246 become closer to each other from the front surface 28A1 side of the upper surface portion 28A of the door trim 28 and from the rear surface 28A2 side of the upper surface portion 28A. Accordingly, after being inserted through the second mounting hole 28C of the upper surface portion 28A, the second coupling pin 236D is inserted (coupled) to the first coupling hoed 247A. Further, after being inserted through the first mounting hole 28B of the upper surface portion 28A, the first coupling pin 236C is inserted (coupled) to the coupling groove 246D.

As illustrated in FIG. 13, the lifted portion 246B is provided on a surface of the clip base board portion 246A that is opposite from the surface on which the coupling groove 246D is formed. The lifted portion 246D overlaps the coupling groove 246D.

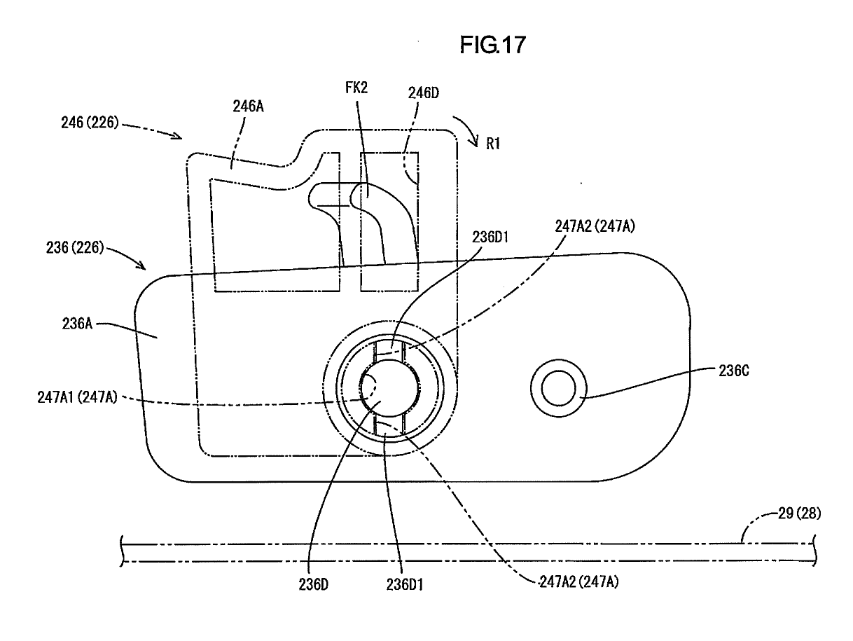

Next, a method of mounting the main body 236 of the hook member 226 and the clip portion 246 to the upper surface portion 28A of the door trim 28 will be explained with reference to FIGS. 14 to 18. FIGS. 17 and 18 illustrate the main body 236 seen from a lower side.

The clip portion 246 is illustrated by a chain double-dashed line in FIGS. 17 and 18. In FIGS. 17 and 18, the upper surface portion 28A of the door trim 28 is not illustrated and a main wall portion 29 of the door trim 28 (a wall portion that is connected to the upper surface portion 28A, refer to FIG. 18) is illustrated by a chain double-dashed line.

First, the main body 236 is attached to the upper surface portion 28A. Specifically, the first coupling pin 236C of the main body 236 is inserted to the first mounting hole 28B of the upper surface portion 28A and the second coupling pin 236D is inserted to the second mounting hole 28C of the upper surface portion 28A. In other words, the second coupling pin 236D of the main body 236 overlaps the second mounting hole 28C.

Accordingly, the main body 236 is fixed in a horizontal direction (in the front-and-rear direction of the vehicle and in the inner-side and the outer-side direction of the compartment). The two pins 236C, 236D are inserted to the mounting holes 28B, 28C, respectively. This prevents the main body 236 from being rotated around one of the two pins. Therefore, the main body 236 and the clip portion 246 are positioned with each other easily in the subsequent mounting process for mounting the clip portion 246.

Next, the clip portion 246 is attached from a lower side to the main body 236 that is fixed to the upper surface portion 28A. Specifically, as illustrated in FIG. 17, the second coupling pin 236D of the main body 236 and the first coupling hole 247A of the clip portion 246 are positioned with each other.

The clip portion 246 is arranged such that the projected portions 236D1 of the second coupling pin 236D overlap the side openings 247A2 of the first coupling hole 247A, respectively. The clip portion 246 is moved closer to the second coupling pin 236D to insert (couple) the second coupling pin 236D to the first coupling hole 247A. Accordingly, the projected portions 236D1 pass through the side openings 247A and arranged at a lower side of the upper wall portion 247 of the cylindrical portion 246C.

Next, the clip portion 246 is rotated around an axis of the second coupling pin 236D by 90 degrees from the state illustrated in FIG. 17. In other words, the clip portion 246 is rotated such that the coupling groove 246D of the clip portion 246 moves closer to the first coupling pin 236C. The rotation direction of the clip portion 246 (the clockwise direction in FIG. 17) is illustrated by an arrow R1 in FIG. 17. When the clip portion 246 is rotated, the lifted portion 246B is held to rotate the clip portion 246 easily.

Due to the rotation of the clip portion 246, the side openings 247A2 do not correspond to the projected portions 236D1. The projected portions 236D1 are stopped by the peripheral edge of the main opening 237A1 of the upper wall portion 247 (in the state of FIG. 15). This prevents the second coupling pin 236D from being dropped off from the first coupling hole 247A and the main body 236 and the clip portion 246 are fixed to each other so as not to be separated from each other.

According to the rotation of the clip portion 246, the coupling groove 246D of the clip portion 246 moves closer to the first coupling pin 236C. Then, after the clip portion 246 is rotated around its axis by 90 degrees from the state in FIG. 17, the arrangement direction of the side openings 247A2 is substantially perpendicular to the arrangement direction of the projected portions 236D1 (the state in FIG. 18). In such a state, the distal end of the first coupling pin 236C is fitted (coupled) to the coupling groove 246D.

Thus, the coupling of the first coupling pin 236C and the coupling groove 246D restricts the rotation of the clip portion 246 with respect to the main body 236. Because the rotation of the clip portion 246 with respect to the main body 236 is restricted, the projected portions 236D1 are restricted to be rotated with respect to the peripheral edge of the main opening 247A1. This restricts that the stoppage of the projected portions 236D1 by the peripheral edge of the main opening 247A1 is released.

According to the above procedure, the main body 236 and the clip portion 246 are coupled to each other with sandwiching the upper surface portion 28A therebetween. Accordingly, the hook member 226 (the main body 236 and the clip portion 246) are mounted to the upper surface portion 28A of the door trim 28.

When the hook member 226 is removed from the upper surface portion 28A, the hook member 226 is removed therefrom by executing the reverse procedure to mounting the hook member 226 to the upper surface portion 28A. The portion of the clip base board portion 246A on which the coupling groove 246D is formed is moved so as to be separated from the first coupling pin 236C of the main body 236 (downwardly in FIG. 14).

Accordingly, the first coupling pin 236C is removed from the coupling groove 246D and the clip portion 246 is rotatable with respect to the main body 236. The lifted portion 246B is provided on a side of the clip base board portion 246A that is opposite side to the surface on which the coupling groove 246D is formed. Therefore, an operator holds and pulls the lifted portion 246B downwardly and this easily moves downwardly the portion of the clip base board portion 246B on which the coupling groove 246D is formed.

The clip portion 246 is rotated with respect to the main body 236 in a counterclockwise direction in FIG. 18 by 90 degrees. Accordingly, the projected portions 236D1 and the side openings 247A2 overlap with each other. Therefore, the second coupling pin 236D is removed from the first coupling hole 247A and the clip portion 246 and the main body 236 are removed from the upper surface portion 28A.

The hook member 226 of the present embodiment is easily mounted to the upper surface portion 28A of the door trim 28 and easily removed from the upper surface portion 28A of the door trim 28. Further, because the hook member 226 is mounted to the upper surface portion 28A of the door trim 28 and accordingly, the hook member 226 is fixed to the upper surface portion 28A. Therefore, the hook member 226 that is mounted to the upper surface portion 28A of the door trim 28 is preferably used as the member that keeps the second blind sheet of the sunshade 18 to be in the extended state.

As illustrated in FIG. 14, a skin 30 is provided on the upper surface portion 28A of the door trim 28 so as to cover the surface 28A1 of the upper surface portion 28A in the second embodiment. The main body 236 is provided on the surface 28A1 of the upper surface portion 28A (on the surface of the skin 30). The clip portion 246 may be provided on the surface 28A2 of the upper surface portion 28A. The clip portion 246 that is to be rotated is provided on the surface on which the skin 30 is not provided. Therefore, the clip portion 246 is easily rotated without having any influence from the skin 30 (for example, friction with the skin 30 caused by flexibility of the skin 30).

Modifications of the above embodiments will be described below.

(1) In the above embodiments, the hook member is provided on an end portion of the upper surface portion of the door trim that is close to the vehicle rear side. However, the mounting portion of the hook member is not limited as long as it is on the upper surface portion of the door trim.

(2) In the above embodiments, the hook member is configured by the main body and the clip portion. However, the configuration of the hook member is not limited thereto and may be altered if necessary.

(3) In the above embodiments, after the upper surface portion of the door trim is sandwiched by the main body and the clip portion of the hook member, the clip portion is rotated to mount the hook member to the upper surface portion of the door trim. However, the mounting manner of the hook member to the upper surface portion of the door trim is not limited thereto and may be altered if necessary.

(4) In the above embodiments, the second sunshade is mounted to the division frame that is a part of the window frame. However, the second sunshade can be mounted to any portion of the window frame.

(5) In the above embodiments, the window frame 14 (at least the bent portion 14B) including no garnish (exposed to an inner space of a vehicle compartment) is preferably formed to be solid. For example, the window frame 14 or at least the bent portion 14B is filled with resin. With the window frame 14 (at least the bent portion 14B) being formed to be solid, rigidity of the window frame 14 (especially the bent portion 14B) is improved and this suppresses occurrence of sympathetic vibration. It is quite difficult to provide a mounting hole to receive the hook member in the solid window frame 14 (especially in the bent portion 14B). However, in the present embodiment, a mounting hole is provided on a portion of the upper surface portion 28A of the door trim 28 that is close to the bent portion and this achieves a configuration in which the hook member that is easily removable is provided on the door trim with having the solid window frame 14.

The embodiments of the present invention have been described, however, the present invention is not limited to the above embodiments explained in the above description and the drawings. The technology described herein includes various modifications of the above embodiments.

Elements of technology described in this specification or illustrated in the drawings exert technical utility by each or a combination thereof. The elements of technology should not be limited to the combinations of the elements claimed in the original patent application. The technology described in this specification or illustrated in the drawings is provided for achieving multiple objectives at the same time. The technical utility of the technology is exerted when at least one of the objectives is achieved.

1. A vehicular door comprising:
a window including an outer rim;
a window frame provided to surround the outer rim of the window;
a sunshade provided to a part of the window frame so as to be extended therefrom and housed therein and configured to be extended to block light entering through the window;
a hook member configured to stop an end of the sunshade to keep the sunshade in an extended state; and
a door trim provided on a lower side of the window and including an upper surface portion that is exposed to the window side, wherein the hook member is mounted on the upper surface portion of the door trim.

2. The vehicular door according to claim 1, wherein the sunshade is configured to be extended and contracted along the upper surface portion of the door trim.

3. The vehicular door according to claim 1, wherein:
the window frame includes a bent portion close to a vehicular rear side, and the bent portion is bent compared to other portions of the window frame; and
the hook member is provided on a portion of the upper surface portion of the door trim that is close to the bent portion.

4. The vehicular door according to claim 2, wherein:
the window frame includes a bent portion close to a vehicular rear side, and the bent portion is bent compared to other portions of the window frame; and
the hook member is provided on a portion of the upper surface portion of the door trim that is close to the bent portion.

5. The vehicular door according to claim 3, wherein the window frame is made of metal and at least the bent portion of the window frame is exposed to an inner space of a vehicular compartment.

6. The vehicular door according to claim 4, wherein the window frame is made of metal and at least the bent portion of the window frame is exposed to an inner space of a vehicular compartment.

7. The vehicular door according to claim 3, wherein the window frame is made of metal and at least the bent portion of the window frame is solid.

8. The vehicular door according to claim 4, wherein the window frame is made of metal and at least the bent portion of the window frame is solid.

9. The vehicular door according to claim 5, wherein the window frame is made of metal and at least the bent portion of the window frame is solid.

10. The vehicular door according to claim 3, wherein the window frame is made of metal and solid.

11. The vehicular door according to claim 4, wherein the window frame is made of metal and solid.

12. The vehicular door according to claim 5, wherein the window frame is made of metal and solid.

13. The vehicular door according to claim 3, wherein the window frame is made of metal and at least the bent portion of the window frame is filled with resin.

14. The vehicular door according to claim 4, wherein the window frame is made of metal and at least the bent portion of the window frame is filled with resin.

15. The vehicular door according to claim 5, wherein the window frame is made of metal and at least the bent portion of the window frame is filled with resin.
